(19) United States
(12) Patent Application Publication
(10) Pub. No.: US 2013/0270124 A1
(43) Pub. Date: Oct. 17, 2013

(54) BIOSENSOR ELECTRODE FOR HER2 DETECTION, A METHOD FOR PRODUCING IT, A METHOD FOR REGENERATING IT

(71) Applicant: RESEARCH & BUSINESS FOUNDATION SUNGKYUNKWAN UNIVERSITY, Suwon-si (KR)

(72) Inventors: Young Kwan LEE, Seoul (KR); Mi Suk CHO, Suwon-si (KR); LiMin CHUN, Seoul (KR)

(21) Appl. No.: 13/737,570

(22) Filed: Jan. 9, 2013

(30) Foreign Application Priority Data
Jan. 9, 2012 (KR) 10-2012-0002526

(51) Int. Cl. G01N 27/327

(52) U.S. Cl. CPC G01N 27/3275
USPC 205/780.5; 204/403.01; 427/77

(57) ABSTRACT

A method of forming a biosensor electrode for HER2 detection is provided. The method includes providing a metal electrode, forming a metal electrode/3-mercaptopropionic acid (MPA) by depositing MPA on the metal electrode, forming a metal electrode/MPA/n-hydroxy-succinimide (NHS) by ester-bonding between NHS and the MPA on the metal electrode/MPA, and forming a metal electrode/MPA/aptamer by amide-bonding between an HER2 specific aptamer having an amino terminus and the MPA of the metal electrode/MPA/NHS.

### BACKGROUND

1. Field of the Invention

The present invention relates to a biosensor electrode for HER2 detection, a method of forming the same, and a method of regenerating the same.

2. Discussion of Related Art

Currently, well-known prognostic factors of breast cancer include the extent of axillary lymph node metastasis, the size of a primary tumor, histopathologic subtypes, a nuclear grade and a histological grade, a proliferation index, estrogen and progesterone receptors, human epidermal growth factor receptor (HER) gene amplification or overexpression, etc.

HER2 is an acronym for human epidermal growth factor receptor 2 and is known as c-erbB-2/neu. HER2 is overexpressed in 25 to 30% of breast cancer patients. In addition, HER2 is one of the most distinctive factors among markers for determining treatment for breast cancer patients. HER2, as an important prognostic factor, is an oncoprotein which was first discovered in chemically induced rat neuroblastoma and has been known to represent gene amplification and a protein overexpression in breast cancer tissues.

An HER2 test is a new diagnosis for invasive breast cancer, which should be regularly performed on patient. However, the best way to evaluate an HER2 status is still remains disputed from the point of view of the type of analysis that is used and the optimal methods. In most cases of most of the promising random adjuvant tests using trastuzumab (Herceptin®), test algorithms for HER2 have been developed somewhat arbitrarily.

Several analyses are being used for tissue-based HER2 measurement. The FDA has approved a fluorescence in situ hybridization (FISH) analysis for clinical trials of HER2 gene amplification, and immunohistochemistry (IHC) for HER2 overexpression.

IHC is a more general but very subjective method. This method may obtain a low level of agreement in terms of an intensity and degree of staining of the tumor membrane. Advantages of IHC testing include wide availability, relatively low cost, easy preservation of a stained slide, and use of familiar routine microscopes. However, disadvantages of IHC include the effect of pre-analytical issues such as storage, duration, and type fixation, the antigen retrieval intensity, the type of an antibody, characteristics of system control samples, and most importantly, difficulties in applying a subjective slide scoring system. Therefore, the results of IHC may vary in practice.

Advantages of FISH technology include a more objective scoring system and the presence of a built-in internal control consisting of HER2 gene signals present in all non-neoplastic tumors in the specimen. Disadvantages of the FISH testing include the higher cost for each test, a longer time required for slide scoring, requirement of a fluorescent microscope, inability to preserve the slides for storage and review, and occasionally, difficulty in identifying the invasive tumor cells.

Inventors of the present invention propose a new label-free electrochemical impedance biosensor in order to overcome the above-described problems of the related art and facilitate sensitive detection of HER2.

### SUMMARY OF THE INVENTION

According to an aspect of the present invention, there is provided a method of forming a biosensor electrode for HER2 detection including providing a metal electrode, forming a metal electrode/3-mercaptopropionic acid (MPA) by depositing MPA on the metal electrode, forming a metal electrode/MPA/n-hydroxy-succinimide (NHS) by ester-bonding between NHS and the MPA on the metal electrode/MPA, and forming a metal electrode/MPA/aptamer by amide-bonding between an HER specific aptamer having an amino terminus and the MPA of the metal electrode/MPA/NHS.

An aptamer is a single strand of nucleic acid (DNA, RNA, or modified nucleic acid) having a stable tertiary structure itself and combining with a target molecule with high affinity and specificity.

The formation of the metal electrode/MPA includes immersing the metal electrode in a solution in which MPA is dissolved in an ethanol-water solvent.

The formation of the metal electrode/MPA/NHS includes immersing the metal electrode/MPA in a solution in which 1-ethyl-3-(3-dimethylaminopropyl)carbodiimide hydrochloride (EDC) and NHS are dissolved in an MES solvent.

The reaction is as follows. The EDC reacts with a carboxyl group of the MPA and activates the MPA, which may be represented by the following reaction formula (1).

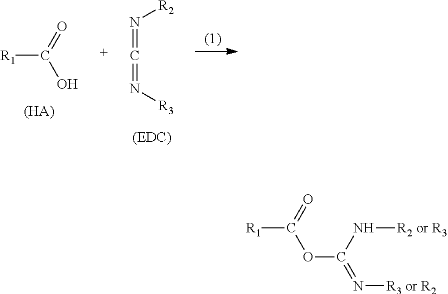

The activated ester compound reacts with NHS to be converted to an NHS ester, which may be represented by the following reaction formula (2).

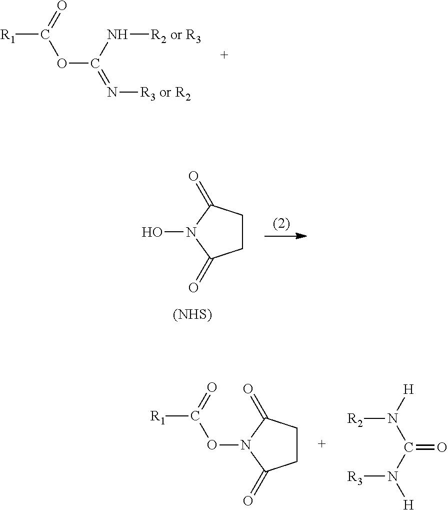

The formation of the metal electrode/MPA/aptamer includes immersing the metal electrode/MPA/NHS in a solution in which an HER2-specific aptamer having an amino terminus is dissolved in an MES solvent.

The reaction is as follows. The NHS ester compound forms an amide bond with an amino group of the aptamer of the present invention, which may be represented by the following reaction formula (3).

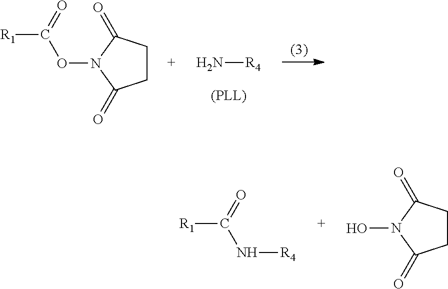

As a result, a metal electrode/MPA/aptamer is obtained.

The HER2-specific aptamer having an amino terminus is amino terminus single-strand DNA (NH₂-ssDNA). The metal electrode may be gold (Au).

According to another aspect of the present invention, there is provided a method of detecting HER2 using the biosensor electrode fabricated by the above described method including immersing the biosensor electrode in a culture medium containing HER2 to bond the HER2 to an aptamer of the biosensor electrode. The culture medium may be blood.

According to still another aspect of the present invention, there is provided a method of regenerating the above described biosensor electrode in which HER2 is detected including providing a metal electrode/MPA/aptamer by immersing the biosensor electrode of a metal electrode/MPA/aptamer/HER2 in a low acidic phosphate buffered saline (PBS) solution to remove the HER2. The pH of the PBS may be about 3 to 4.

According to still another aspect of the present invention, there is provided a biosensor electrode for HER2 detection in which an HER2 specific aptamer having an amino terminus is coupled on a metal electrode. The coupling on the metal electrode includes deposition of 3-mercaptopropionic acid (MPA) on the metal electrode, and amide bonding of an aptamer having the amino terminus of the MPA. The HER2 specific aptamer having the amino terminus is amino terminus single-strand DNA (NH₂-ssDNA). The metal electrode may be gold (Au).

According to still another aspect of the present invention, there is provided a method of forming a biosensor electrode for HER2 detection including providing a metal electrode, forming a metal electrode/MPA by immersing the metal electrode in a solution in which MPA is dissolved in an ethanol-water solvent, forming a metal electrode/MPA/NHS by immersing the metal electrode/MPA in a solution in which EDS and NHS are dissolved in an MES solvent, and forming a metal electrode/MPA/aptamer by immersing the metal electrode/MPA/NHS in a solution in which an HER2 specific aptamer having an amino terminus is dissolved in an MES solvent.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a schematic diagram showing an experimental method of fabricating an electrode of the present invention;

FIG. 2 shows Nyquist plots of different electrodes in a PBS (10 mM, pH 7.4) solution;

FIG. 3A shows Nyquist plots of the modified gold electrode having an aptamer (NH₂-ssDNA) after being incubated in various concentrations of HER2/PBS;

FIG. 3B shows a linear relationship (5.0 to 50 ngmL⁻¹) between concentrations of HER2 (5.0 to 500 ngmL⁻¹) and ΔRₑₜ;

FIG. 4 shows regeneration data of a modified gold electrode of the present invention at each immobilizing step; and

FIG. 5 shows Nyquist plots of an HER2-modified electrode showing a selectivity of the HER2-modified electrode by immersing an electrode of the present invention in different protein solutions (BSA, IgG).

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications and changes can be made without departing from the spirit and scope of the invention.

1. Experiment

Materials and Apparatus

3-mercaptopropionic acid (MPA), 2-(N-morpholino)ethanesulfonic acid (MES), N-hydroxy-succinimide (NHS), 1-ethyl-3-(3-dimethylaminopropyl)carbodiimide hydrochloride (EDC), K₃Fe(CN)₆, and K₄Fe(CN)₆ were purchased from Sigma-Aldrich and used without further purification.

Bovine serum albumin (BSA) and immunoglobulin (IgG) were purchased from Sigma-Aldrich.

An NH₂ aptamer was synthesized from an aptamer having HER2 specific DNA sequences (5′-Amino Modifier C6-CTT CTG CCC GCC TCC TTC C-(TGGGGCCTGGATACGGATTGGTAAGGATTAGTAGGGGGCATAGCT)-GGA GAC GAG ATA GGC GGA CAC T-3′) of the present invention learnt from a symposium (“Screening of ssDNA Aptamers for HER2 ECD Protein,” Symposium on Biotechnology and Bioengineering—Korean Society for Biotechnology and Bioengineering, Oct. 5, 2011), by Miotech. In addition, the HER2 was provided by R&D Systems. The aptamer and the HER2 were dissolved in 20 mM phosphate buffer (pH 6.0) containing 20 mM KCl and 1.5 mM MgCl₂.

All solutions were fabricated from ultrapure water (resistivity: 18.2 MΩ/cm) through a Millipore MilliQ water purification system. Glassware was autoclaved before use.

All electrochemical experiments were performed using VSR Potentiostat (Princeton Applied Research, USA), and the resultant curves were recorded using a VSP EC-Lab software.

A conventional three-electrode cell was used for performing electrochemical impedance spectroscopy (EIS). Ag/AgCl and a platinum (Pt) plate were respectively used as a reference electrode and an opposite electrode. In every modification and detection stage, an operating electrode was detected by EIS in a 2 mM Fe(CN)6^{3-/4-}(1:1)/PBS solution. An amplitude-sine wave of about 10 mV was applied in a frequency range of about 0.1 Hz to 100 kHz.

Impedance spectra were fitted to a Randles equivalent circuit for the modified electrodes with/without HER2, which includes dissolution resistivity Rₛ, a constant C, a charge-transfer resistance R_{ct}, and Warburg impedance Z_{w}.

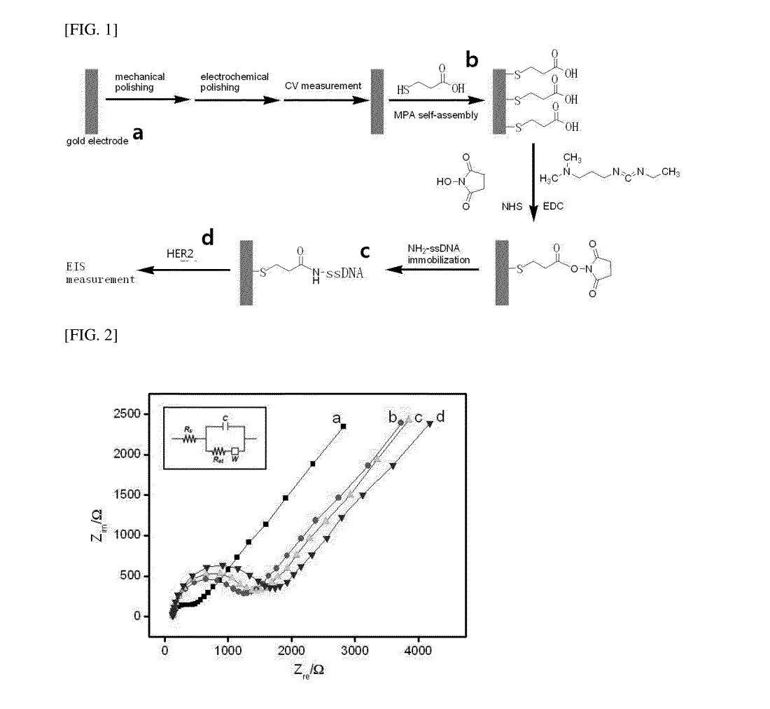

FIG. 1 is a schematic diagram showing a method of fabricating a biosensor electrode of the present invention. Particularly, FIG. 1 is a schematic diagram showing an experimental method of forming the electrode.

Preparation of Gold Electrode

The preparation of a gold electrode corresponds to step a in FIG. 1. A gold electrode with a diameter of 2.0 mm was prepared. The gold electrode was polished using 0.05 nm alumina (Al₂O₃) powder and thoroughly washed with distilled water. The gold electrode was subsequently ultrasonicated in ethanol and in water for 20 minutes each, and then washed with distilled water. The gold electrode was immersed in a piranha solution (30% H₂O₂/98% H₂SO₄ (1/3, v/v)) for 30 minutes, and then washed with distilled water. The polished gold electrode was subjected to cyclic voltammetry in a 1 M HClO₄ solution with a voltage range of 0 to 1.5 V at a scan rate of 100 mVs⁻¹ for 30 cycles and then washed with distilled water.

Formation of MPA Layer on Gold Electrode

The formation of an MPA layer on the gold electrode corresponds to step b in FIG. 1. The gold electrode was immersed in 20 mM MPA (in 3:1 v/v ethanol/water) overnight to form a self-assembled layer of MPA on the gold electrode, and then washed with water, after which the next step was carried out.

NHS Bonding on Au/MPA Electrode

The Au/MPA electrode was immersed in an EDC/NHS solution (pH=6.0) in 10 mM MES for 10 minutes in order to couple the NHS with the Au/MPA.

The reaction process is as follows. The carboxyl group of MPA reacts with EDC to be activated. The activated ester compound reacts with NHS to be converted to an NHS ester. As a result, NHS is coupled with Au/MPA.

The NHS coupled with the Au/MPA was washed with distilled water for use in a next step.

NH₂-ssDNA Bonding on Au/MPA Electrode

The Au/MPA/NHS electrode acquired in the previous step was dipped in a 2 nM NH₂-ssDNA/PBS solution for 30 minutes to form amide bonds on the self-assembled layer of the MPA and to immobilize an aptamer.

HER2 Detection

After immobilization of the NH₂-ssDNA, the modified gold electrode was incubated in a series of HER2/PBS solutions of different concentrations for 30 minutes each, and then washed with DI water. A series of HER2/PBS solutions of 5 ng/ml to 500 ng/ml concentrations were fabricated in order to confirm a range of soluble concentration.

Sensor Regeneration

Regeneration of the HER2-modified electrode was performed by immersing the HER2-modified electrode in a PBS buffer solution (pH=4.0) for 15 minutes after each measurement. Almost all of the HER2 was removed from the electrode by the regeneration process.

Evaluation of Selectivity of Sensor

In order to evaluate the selectivity of the modified gold electrode, available interfering materials were dissolved in a PBS solution. The modified gold electrode was immersed in other proteins, that is, bovine serum albumin (BSA) and immunoglobulin (IgG), and changes in resistivity were observed according to the proteins.

2. Experimental Results

Electrochemistry of NTA-Cu Sensor

An electrical property of the NTA-Cu electrode was measured by an EIS response. EIS generally provides detailed information of changes in a surface during a modification process. A typical impedance spectrum (provided in the form of a Nyquist plot) provides a semicircle portion at higher frequencies corresponding to an electron-transfer-limited process, and a linear portion at lower frequencies corresponding to a diffusion-limited process. A diameter of the semicircle part in the impedance spectrum refers to an electron-transfer resistance (Rₑₜ.), which reflects an electron-transfer movement of a redox probe in a surface of the electrode. (Ding et al., 2007; Qiu et al., 2009; Baur et al., 2010).

FIG. 2 shows Nyquist plots of different electrodes in a PBS solution (10 mM, pH 6.0) containing 2 mM Fe(CN)₆^{3-/4-}; (a) bare gold, (b) Au/MPA modified electrode, (c) Au/MPA/NH₂-ssDNA, and (d) Au/MPA/NH₂-ssDNA/HER2 complex formed by dipping the modified electrode in 5.0 ng.ml⁻¹ for 30 minutes. The range of frequency is from 0.1 Hz to 100 KHz, and AC amplitude is 10 mV.

A drawing inserted in FIG. 2 shows an equivalent circuit used for modeling impedance data in the presence of a redox couple. Rs, W, Rₑₜ, and C respectively represent solution resistance, Warburg-diffusion resistance, electron-transfer resistance, and double-layer capacitance.

Plot a in FIG. 2 shows that the bare gold made an almost straight Nyquist plot. After the deposition of the MPA and the aptamer, the apparent semicircle up to the intermediate frequency range shows the electron-transfer-limited process. This EIS data shows a successful formation of each step in which the electrochemical probe interrupts the electron-transfer. A significant difference in electron-transfer resistance (Rₑₜ) was observed in each modified electrode formed at each modification step. Rₑₜ of the Au/MPA is greater than that of the bare gold electrode. This shows that the formation of the MPA SAM causes blocking of the electron-transfer from a redox probe [Fe(CN)₆^{3-/4-}] to a surface of the electrode. When HER2 is immobilized, Rₑₜ of the modified gold electrode is additionally increased. This is considered to be caused by an electronegative region which probably blocks [Fe(CN)₆^{3-/4-}] ions from reaching the surface of the electrode to transfer electrons during the redox reaction. The HER2 of the electrode functions as a blocking layer that blocks the electron-transfer and mass-transfer. In addition, the HER2 of the electrode insulates the conductive support and greatly interrupts access of the redox probe to the surface of the electrode. As a result, an additional increase in Rₑₜ is observed.

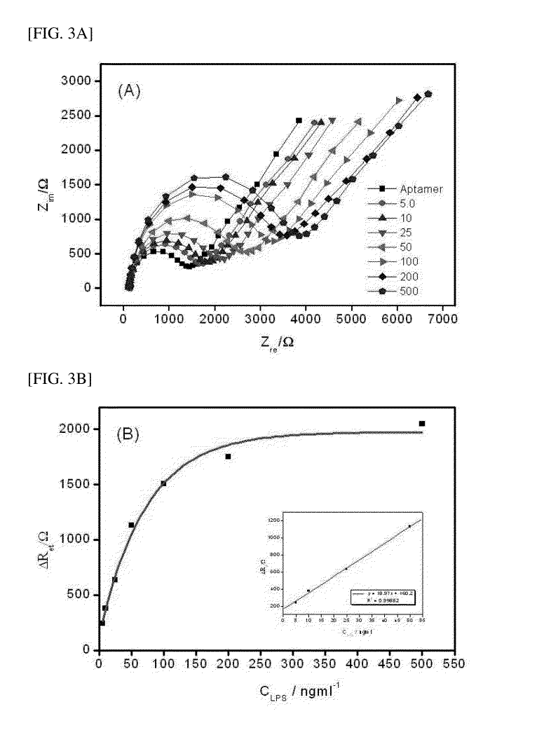

FIG. 3A shows Nyquist plots of the modified gold electrode having the aptamer (NH₂-ssDNA) after being incubated in various concentrations of HER2/PBS. FIG. 3B shows a linear relationship (5.0 to 50 ngmL⁻¹) between HER2 concentrations (5.0 to 500 ngmL⁻¹) and ΔRₑₜ.

After the aptamer (NH₂-ssDNA) was immobilized, the modified gold electrode was incubated in a series of HER2/PBS solutions of a range 5.0 to 50 ngmL⁻¹. The modified gold electrode was detected by EIS after each incubation. The difference of electron-transfer resistance ΔRₑₜ between the aptamer-modified gold electrode and the HER2-incubated gold electrode was obtained from a signal formed by a reaction between the immobilized aptamer and the HER2.

ΔRₑₜ=Ret, i−R_{et,aptamer}, i=5, 10, 25, 50, 100, 200, 500

As shown in FIG. 3, the increase of Rₑₜ is proportional to the HER2 concentration with the range of 5.0 to 50 ngmL⁻¹, and the linear progression may be formularized as y=18.97x+160.2(R²=0.99882). The formula shows the linear relationship between the ΔRₑₜ value and the HER2 concentrations in the above concentration range. In addition, it was confirmed that the ΔRₑₜ value converges in the concentration range of from 50 ng/ml to 500 ng/ml, which means that the fabricated electrode may detect the HER2 having a concentration range of from 5 to 500 ng/ml.

Additionally, the gold electrodes were fabricated several times and modified several times by the same processes. The obtained results were similar every time, which shows a superior time-to-time regenerative property of the above-described fabrication protocol.

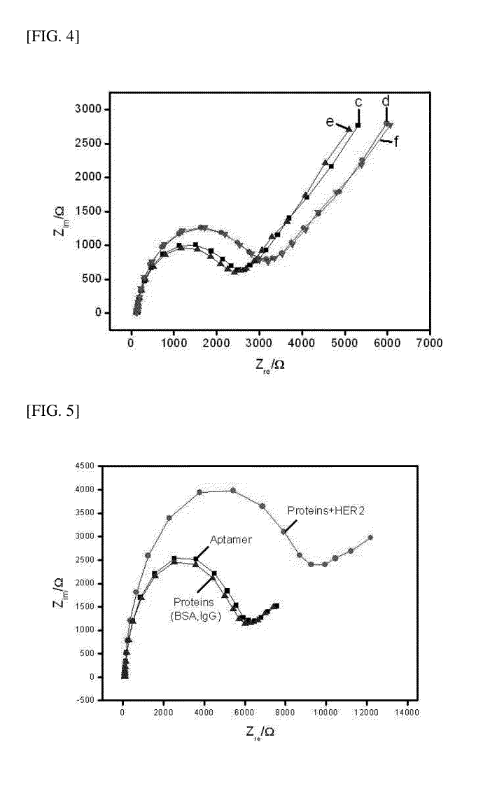

FIG. 4 shows regeneration data of a modified gold electrode of the present invention at each immobilization step.

An HER2-collected electrode was immersed in PBS (pH=4) for 15 minutes. The obtained resistivity (e) was the same as the resistivity of the aptamer-modified electrode. Next, the modified electrode was re-immersed in an HER2/PBS (pH=6) solution (30 ng/ml) for 30 minutes. The resistivity (f) was the same as the resistivity of the HER2-modified electrode.

Accordingly, it can be seen that the aptamer collects HER2 in a buffer solution including pH=6 HER2 and does not detect HER2 in a buffer solution including pH=4 HER2.

An electrode fabricated using this property may be generated after collecting HER2 by controlling the pH of the buffer, and may have an excellent regenerating ability.

FIG. 5 shows Nyquist plots of an HER2-modified electrode showing a selectivity of the HER2-modified electrode when an electrode of the present invention is immersed in different protein solutions, that is, bovine serum albumin (BSA) and immunoglobulin (IgG).

EIS data was measured to investigate specificities of the aptamer with respect to other proteins existing blood, such as BSA and IgG. The EIS data of the aptamer-attached electrode was measured (block line), and then the aptamer-attached electrode was immersed in 20 μg/ml concentrations of BSA solution and IgG solution each for 30 minutes. The Rₑₜ value did not change. Then, when the aptamer-attached electrode was immersed in a solution in which 30 ng/ml HER2 was added to a 20 μg/ml BSA/IgG solution for 30 minutes, the Rₑₜ value increased. That is, the electrode fabricated using the aptamer having specificity with respect to the HER2 does not have specificity with respect to other proteins in the blood, and therefore, has excellent selectivity without being influenced by the other proteins in the blood.

It will be apparent to those skilled in the art that various modifications and changes can be made to the above-described exemplary embodiments of the present invention without departing from the scope of the invention. Thus, it is intended that the present invention covers all such modifications and changes provided they come within the scope of the appended claims and their equivalents.

1. A method of forming a biosensor electrode for HER2 detection, comprising:
providing a metal electrode;
forming a metal electrode/3-mercaptopropionic acid (MPA) by depositing MPA on the metal electrode;
forming a metal electrode/MPA/n-hydroxy-succinimide (NHS) by ester-bonding NHS and the MPA on the metal electrode/MPA; and
forming a metal electrode/MPA/aptamer by amide-bonding an HER2 specific aptamer having an amino terminus and the MPA of the metal electrode/MPA/NHS.

2. The method according to claim 1, wherein the formation of the metal electrode/MPA comprises immersing the metal electrode in a solution in which MPA is dissolved in an ethanol-water solvent.

3. The method according to claim 1, wherein the formation of the metal electrode/MPA/NHS comprises immersing the metal electrode/MPA in a solution in which 1-ethyl-3-(3-dimethylaminopropyl)carbodiimide hydrochloride (EDC) and NHS are dissolved in a 2-(N-morpholino)ethanesulfonic acid (MES) solvent.

4. The method according to claim 1, wherein the formation of the metal electrode/MPA/aptamer comprises immersing the metal electrode/MPA/NHS in a solution in which an HER2-specific aptamer having an amino terminus is dissolved in an MES solvent.

5. The method according to claim 1, wherein the HER2-specific aptamer having an amino terminus is amino terminus single-strand DNA (NH₂-ssDNA).

6. The method according to claim 1, wherein the metal electrode is gold (Au).

7. A biosensor electrode for HER2 detection obtained by the method according to claim 1.

8. A method of detecting HER2 using the biosensor electrode according to claim 7, comprising:
immersing the biosensor electrode in a culture medium containing HER2 to bond the HER2 to an aptamer of the biosensor electrode.

9. The method according to claim 8, wherein the culture medium is blood.

10. A method of regenerating the biosensor electrode in which HER2 is detected by the method according to claim 8, comprising:
providing a metal electrode/MPA/aptamer by immersing the biosensor electrode of a metal electrode/MPA/aptamer/HER2 in a low acidic phosphate buffered saline (PBS) solution to remove HER2.

11. The method according to claim 10, wherein the pH of the PBS is about 3 to 4.

12. A biosensor electrode for HER2 detection, comprising:
an HER2 specific aptamer having an amino terminus coupled on a metal electrode.

13. The biosensor electrode for HER2 detection according to claim 12, wherein the coupling on the metal electrode comprises deposition of 3-mercaptopropionic acid (MPA) on the metal electrode, and amide-bonding of an aptamer having an amino terminus of the MPA.

14. The biosensor electrode for HER2 detection according to claim 12, wherein the HER2 specific aptamer having the amino terminus is amino terminus single-strand DNA (NH₂-ssDNA).

15. The biosensor electrode for HER2 detection according to claim 12, wherein the metal electrode is Au.

16. A method of forming a biosensor electrode for HER2 detection, comprising:
providing a metal electrode;
forming a metal electrode/MPA by immersing the metal electrode in a solution in which MPA is dissolved in an ethanol-water solvent;
forming a metal electrode/MPA/NHS by immersing the metal electrode/MPA in a solution in which EDS and NHS are dissolved in an MES solvent; and
forming a metal electrode/MPA/aptamer by immersing the metal electrode/MPA/NHS in a solution in which an HER2 specific aptamer having an amino terminus is dissolved in an MES solvent.
